(19) United States
(12) Patent Application Publication
(10) Pub. No.: US 2025/0137441 A1
(43) Pub. Date: May 1, 2025

(54) GRAVITY POWERED HYDRAULIC PISTON ENGINE AND GRAVITY POWERED HYDRAULIC PISTON ENGINE GENERATOR APPARATUS AND METHODS TO USE THE SAME

(71) Applicant: Stephen Rodney Fine, Henniker, NH (US)

(72) Inventor: Stephen Rodney Fine, Henniker, NH (US)

(21) Appl. No.: 18/436,762

(22) Filed: Feb. 8, 2024

Related U.S. Application Data
(60) Provisional application No. 63/576,469, filed on Feb. 13, 2023.

(51) Int. Cl. H02K 7/18; F03G 3/00; F15B 15/14; H02K 7/116

(52) U.S. Cl. CPC F03G 3/094; F15B 15/1447; F05B 2260/406; F05B 2260/503

(57) ABSTRACT

An apparatus and method for the generation of clean electric power. A gravity powered reciprocating piston engine having a fluid chamber with a first and second piston chamber. A first piston and second piston positioned within the first and second piston chambers respectively. The piston rod of each of the first and second piston extending outside of the piston chamber. A mechanical connection extends between the first piston rod and second piston rod, wherein the second piston rod has a leverage advantage over the first piston rod when the mechanical connection is enabled. A fluid control connected to the fluid chamber, where the first piston has leverage advantage over the second piston when the fluid chamber and piston chambers are full of fluid.

### CROSS REFERENCE TO RELATED APPLICATION

This application claims benefit of U.S. Provisional Application Ser. No. 63/576,469 filed Feb. 13, 2023, the entire disclosure of which is incorporated herein by reference.

### FIELD OF THE DISCLOSURE

The present disclosure is generally related to engines and more particularly is related to hydraulic piston engines and hydraulic piston engine generator apparatus and methods to use the same.

### BACKGROUND OF THE DISCLOSURE

Fossil fuels and the like have been used to power engines, since their inception.

However, while operating between a 20%-60% efficiency and the large carbon footprint attributed to their byproducts, a new engine is needed to increase efficiency and decrease or eliminate the harmful byproduct.

A piston is a component of reciprocating engines and various other mechanisms. In a combustion engine, the piston transfers force from the expanding gas in the cylinder to the crankshaft. To get away from fossil fuels, while maintaining significant existing elements of present engine designs, it is desirable to find a way to drive a piston without fossil fuels. Currently, the most commonly used piston-engine is the internal combustion engine. While the internal combustion engine has been tried and proven over the years to be highly reliable, it suffers from a lack of efficiency. While large amounts of energy can be produced by converting the potential energy of gasoline into rotational kinetic energy, much of it is lost in the form of heat.

For the above reasons, the internal combustion engine has remained the primary source of energy for gas-powered generators, but other issues arise with increasing concerns of environmentalism. As more research indicates the dangers internal combustion engines have on the environment, there is a push to move away from their use.

Thus, a heretofore unaddressed need exists in the industry to address the aforementioned deficiencies and inadequacies.

### SUMMARY OF THE DISCLOSURE

Embodiments of the present disclosure provide an apparatus and method for the generation of clean electric power. Briefly described, in architecture, one embodiment of the system, among others, can be implemented as follows. An engine contains a fluid chamber including a first piston chamber and a second piston chamber. A first piston is positioned within the first piston chamber and a first piston rod is connected to the first piston, extending outside of the first piston chamber. A weight is mounted on the first piston rod. A second piston is positioned within the second piston chamber and a second piston rod is connected to the second piston to extend outside of the second piston chamber. A weight is mounted on the second piston rod. A mechanical connection extends between the first piston rod and the second piston rod, wherein the second piston rod has a leverage advantage over the first piston rod when the mechanical connection is enabled. A fluid control is connected to the fluid chamber for influencing fluid content of the fluid chamber. The first piston has a leverage advantage over the second piston when the piston chambers are full of fluid at a sufficient pressure greater than atmosphere imposed by the weight mounted on the first piston rod.

Briefly described, in terms of function, this invention harnesses the power of gravity through directly transmitting the energy of two interconnected reciprocating falling weights into the reciprocating linear motion of two piston rods. The reciprocation of the falling weights is initiated and sustained by low energy fluid transfer. To initiate the falling of the weights, unpressurized fluid is injected into a top portion of the fluid chamber. The system is sustained with high efficiency, where fluid in the top portion becomes pressurized by the falling of the weights, and the pressurized fluid is ejected into a dump reservoir.

The present disclosure can also be viewed as providing methods of using the engine. In this regard, one embodiment of such a method, among others, can be broadly summarized by the following steps: Connecting a top end of one of the piston rods to a conversion assembly. Converting the linear motion of one of the piston rods into rotational motion with the conversion assembly. Connecting a first end of the driveshaft to the motion converted. Connecting a second end of the driveshaft to the generator. Generating at least one electrical power source configured to connect to an electrical power input.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a cross-sectional view of an engine with a first piston in its maximum up-travel position and a second piston at its maximum down-travel position.

FIG. 2 illustrates the cross-sectional view of FIG. 1 where the engine is at the initiation of the first piston downstroke and the second piston upstroke.

FIG. 3 illustrates the cross-sectional view of FIG. 1 where the engine is at the end of the first piston downstroke and the second piston upstroke, where the first piston is at its maximum down-travel position and the second piston is at its maximum up-travel position.

FIG. 4 illustrates the cross-sectional view of FIG. 1 where the engine is at the initiation of the upstroke of the first piston and the downstroke of the second piston.

FIG. 5 illustrates a schematic of an engine-generator assembly.

FIG. 6 illustrates a flowchart method to use the engine-generator assembly of FIG. 5.

### DETAILED DESCRIPTION

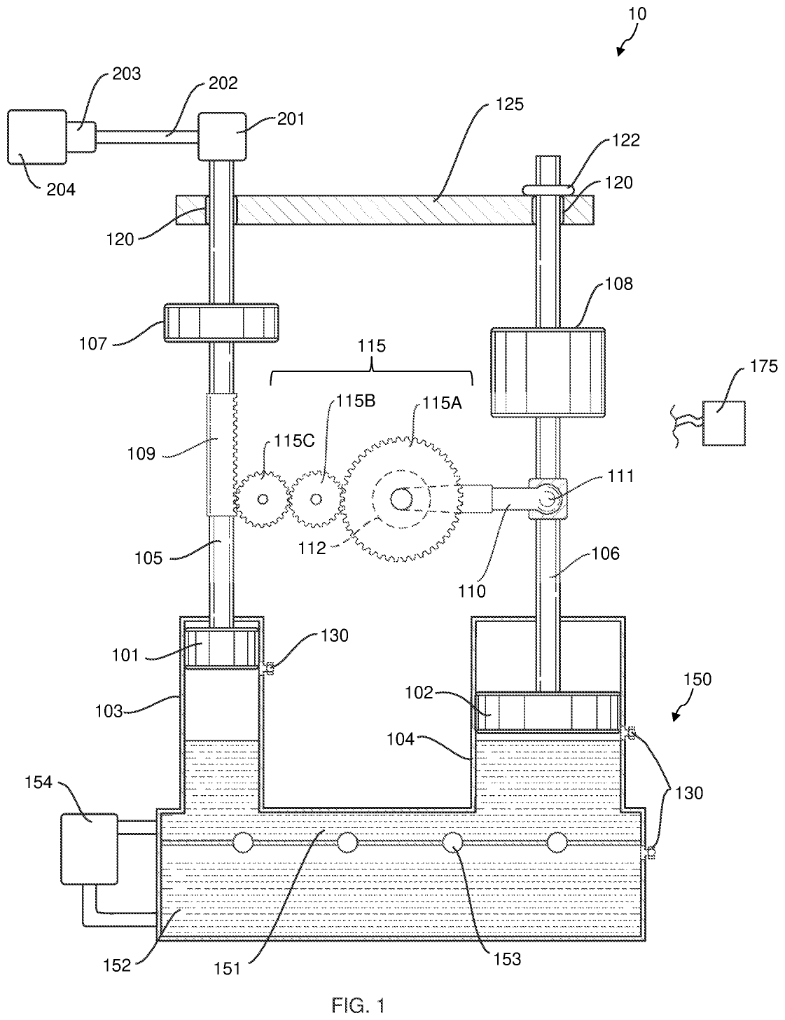

FIG. 1 illustrates a cross-sectional view of an engine 10 with a first piston 101 in its maximum up-travel position and a second piston 102 in its maximum down-travel position. The engine 10 contains a fluid chamber 150 that has a first piston chamber 103 and a second piston chamber 104. The first piston 101 is positioned within the first piston chamber 103 and is connected to a first piston rod 105 extending outside of the first piston chamber 103. A second piston 102 is positioned within the second piston chamber 104 and is connected to a second piston rod 106 extending outside of the second piston chamber 104.

The first piston rod 105 and the second piston rod 106 are designed for reciprocal motion, such that the first piston 101 is at the top of the first piston chamber 103 when the second piston 102 is at the bottom of the second piston chamber 104 and the first piston 101 is at the bottom of the first piston chamber 103 when the second piston 102 is at the top of the second piston chamber 104.

As depicted in FIG. 1, a diameter of the first piston 101 is smaller than a diameter of the second piston 102. Slight, non-material variations in the height of the first piston 101 or second piston 102 will not affect the structure nor the operation of the engine 10. In the preferred example, the second piston 102 has a diameter 5 times larger than the diameter of the first piston 101.

The first 101 and second 102 piston may be made out of plastic, metal, metal alloys, concrete, composite, or any other material. The first 101 and second 102 piston must be made such that they can withstand high fluid pressure and heavy weight. The pistons 101, 102 must not deform under heavy weight or high fluid pressure. The pistons 101, 102 must maintain a fluid-tight and/or airtight seal with the inner circumference of the piston chambers 103, 104. A fluid-tight and/or airtight seal can be achieved by precision construction of the pistons 101, 102 and the piston chambers 103, 104. In another example, piston rings may be used. Piston rings may be added to the outer circumference of each of the first 101 and second 102 pistons to ensure a fluid-tight and/or airtight seal with the inner circumference of each of the piston chambers 103, 104. In one example, a singular piston ring may be used to ensure the fluid-tight and/or airtight seal. In other examples, multiple piston rings may be used on each of the pistons 101, 102 to ensure the integrity of the fluid-tight and/or airtight nature of the system.

In some examples, the second piston rod 106 is materially heavier than the first piston rod 105. The first piston rod 106 may be made heavier by a difference in materials used in the construction of the first 105 and second 106 piston rods respectively. In some examples, the density of the material or composite material used to form the second piston rod 106 may be materially greater than that which is used to form the first piston rod 101, such that the second piston rod 106 is materially heavier than the first piston rod 101.

The upper portion of the first piston rod 105 may have a first weight platform 107 and the upper portion of the second piston rod 106 has a second weight platform 108. Each of the first 107 and second 108 weight platforms are placed above the mechanical connection 115.

The first 107 and second 108 weight platforms are weighted. The second weight platform 108 is materially heavier than the weight of the first weight platform 107. In other examples, the first 107 and second 108 weight platforms themselves have no meaningful difference in weight, and thus, weight will need to be placed on the weight platforms 107, 108. In some examples, the weights may be of toroidal shape, forming weight plates that may be stackable. In this example, weights can be added and removed as desired for the operation of the engine 10. The weight plates may be made out of any substance with a density greater than 1.0 g/cm³. In other examples, a weight may be a solid structure which is placed on top of each of the first 107 and second 108 weight platforms. In yet another example, the first 107 and second 108 weight platforms may have hollow containers to receive a substance that adds meaningful weight. The container would be such that it can hold fluid, sand, gravel, rocks, cement, or any other material for precise weight adding purposes.

The engine 10 may have a stabilization platform positioned above the weight platforms. The stabilization platform 125 has two apertures for receiving the first 105 and second 106 piston rods, each aperture having a friction reducer 120.

The stabilization platform 125 may be made of any material which is capable of keeping the first 105 and second 106 piston rods vertical, with very low to no risk of deforming over time from friction or heat. Such materials would include constructing the stabilization platform 125 with concrete, metal, metal alloy, or other composite material that is capable of tolerating at least some heat generated by friction.

In some examples, the second piston rod 106 may have at a top end above the stabilization platform 125 a piston rod stopper 122, which suspends the second piston rod 106 from the stabilization platform 125 at the end of the downstroke of the second piston 102 to unweight the pressure on the ratcheting mechanism 112 at the end of the downstroke of the second piston 102 to facilitate disengagement of the ratcheting mechanism 112 for initiation of the downstroke of the first piston 101, as hereinafter explained.

To reduce friction from the linear reciprocation of the first 105 and second 106 piston rods, friction reducers 120 may be added to the inner circumference of the two apertures of the stabilization platform 125. In some examples, friction reducers 120 may be in the form of a low friction insert, where an insert is positioned to cover at least a portion of the inner circumference of each aperture in the stabilization platform 125 to reduce friction from the linear motion of each of the first 105 and second 106 piston rods. In other examples the friction reducers 120 may be in the form of a linear bearing positioned inside of each aperture in the stabilization platform 125 to reduce friction from the linear motion of each of the first 105 and second 106 piston rods. In yet another example, the friction reducers may be in the form of a liquid or powder lubricant. The lubricant may be, but is not limited to an oil composition, or graphite liquid or powder. In some examples, a second stabilization platform 125 may be added below the mechanical connection 115 for additional stability as needed to keep each of the piston rods 105, 106 vertical. The second stabilization 125 platform also has two apertures to receive each of the first 105 and second 106 piston rods. The second stabilization platform 125 may utilize the same friction reducing methods as is exemplified in the friction reducing examples of the stabilization platform 125 located above the first 107 and second 108 weight platform.

The first 105 and second 106 piston rods are interconnected by a mechanical connection 115 which may include a gear train terminating at a rack gear 109 on the first piston rod 105 and terminating at a lever bar, 110 connected to the second piston rod 106. The mechanical connection 115 may be formed by one or more gears. One having ordinary skill in the art will understand how to connect multiple gears to create a leverage advantage. As an example, employing different gear sizes may be used to create a leverage advantage. The gear ratio of the mechanical connection 115 starting from the first piston rod 105 is calibrated to match the hydraulic leverage which the first piston 101 has over the second piston 102 when the piston chambers 103, 104 are full of fluid. Consequently, during the upstroke of the first piston 101, which occurs when the mechanical connection 115 is engaged by the fall of the second piston 102, the gear ratio translates the shorter distance of the second piston's 102 descent into a longer rise distance of the first piston 101 equal to the first piston's 101 descent distance during its downstroke. If, for instance, the first piston's 101 hydraulic leverage over the second piston 102 is 5:1, then on the downstroke of the first piston 101, the first piston 101 will travel 5 times further during the downstroke than the upward movement of the second piston 102. However, on the downstroke of the second piston 102, as subsequently explained, the gravitational force of the second piston's 102 fall is transmitted to the first piston rod, 105, via the lever bar 110 and the mechanical connection 115 resulting in the upper movement of the first piston 101 five times further than the movement of the second piston 102. On the downstroke of the first piston 101 when it has hydraulic leverage over the second piston 102, the mechanical connection 115 merely tracks the movement of the two piston rods 105, 106 without transmitting the force of the descent of the first piston 101. On the downstroke of the second piston 102 and the upstroke of the first piston 101, the lever bar 110 is intended to compensate for the loss of mechanical leverage resulting from the 1:5 gear ratio which reverses the favorable hydraulic leverage which the first piston 101 has over the second piston 102.

As previously discussed, the mechanical connection 115 between each of the piston rods 105, 106, further contains a lever bar 110. The lever bar 110 is pivotally connected to the second piston rod 106. The connection between the lever bar 110 and the second piston rod 106 may be a ball and socket joint 111, or other pivoting mechanism.

The lever bar is configured to connect with a ratcheting mechanism 112 of the mechanical connection 115. In some examples the ratcheting mechanism 112 may be a solenoid operated ratcheting mechanism 112. The ratcheting mechanism 112 disengages counterclockwise rotation of a first gear 115a by the lever bar 110 when deactivated, and when activated, engages the lever bar's 110 clockwise rotation of the first gear 115a. Hence, the movement and force of the second piston rod's 106 fall during its downstroke is transmitted to the first piston rod 105 through the mechanical connection 115, while the first gear 115a is rotating clockwise, and the lever bar 110 is engaged. However, the downstroke of the first piston 101 results in the counterclockwise rotation of the first gear 115a, such that the first gear 115a rotates free of its connection with the lever bar, 110, which then offers no resistance to the upper movement of the second piston rod 106.

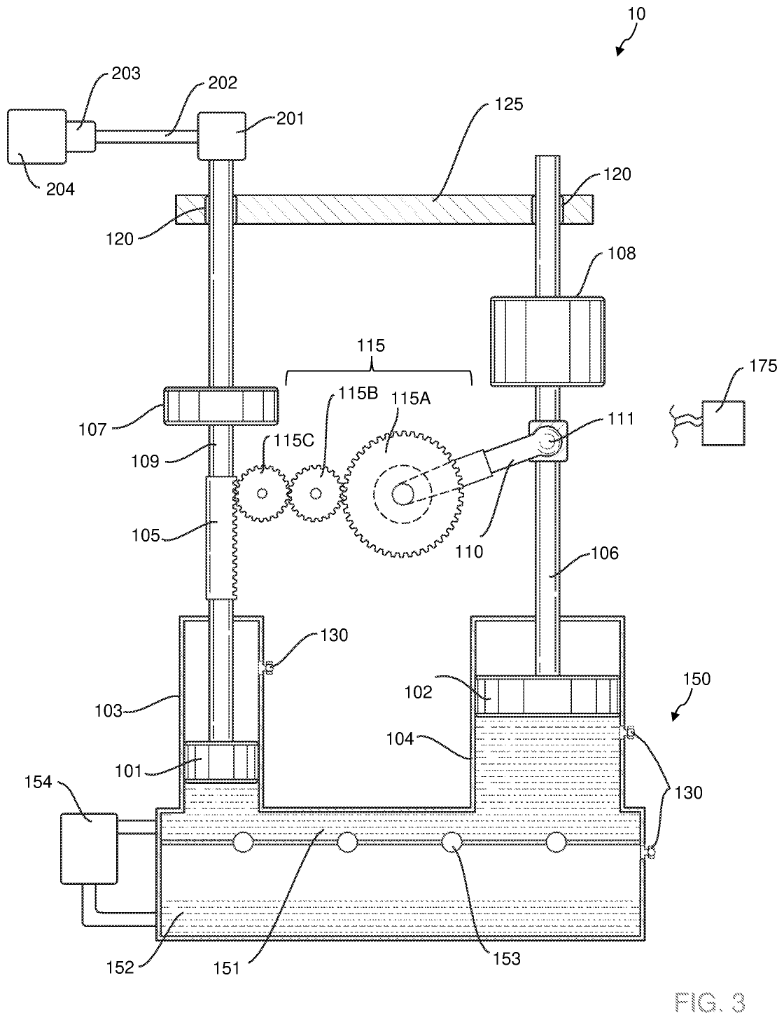

In the present disclosure, two different mechanisms exist to enable reciprocal motion, the mechanical connection 115 coupled with the lever bar 110, and the fluid chamber 150 when under pressure. The reciprocal motion is created in part by alternating which mechanism is enabled and which mechanism is disabled. As described herein, the second piston rod 106 has leverage over the first piston rod 105 when the mechanical connection 115 is enabled. When the second piston 102 is at the top of its upstroke, if the mechanical connection 115 is enabled and the piston chambers 103, 104 are open such that the fluid level in the second piston chamber 104 is below the second piston's 102 furthest travel point on its downstroke, gravity will draw the second piston 102 downward and use the leveraged mechanical connection 115 to draw the first piston 101 upward. When piston 101 is at the top of its upstroke and the second piston 102 is at the bottom of its downstroke, and the mechanical connection 115 between the piston rods 107, 106 is disengaged by the ratcheting mechanism, 112, and when the piston chambers 103, 104 are filled with fluid, gravity will draw the first piston 101 down and use the leverage of the fluid chamber 150 to push the second piston 102 up as illustrated in FIG. 3

In some examples, the mechanical connection 115 contains a first gear 115a, a middle gear 115b, and a final gear 115c. The middle gear 115b mechanically articulates with the first gear 115a and final gear 115c. The final gear 115c directly mechanically engages with a rack gear 109 which may be an integral part of piston rod 105.

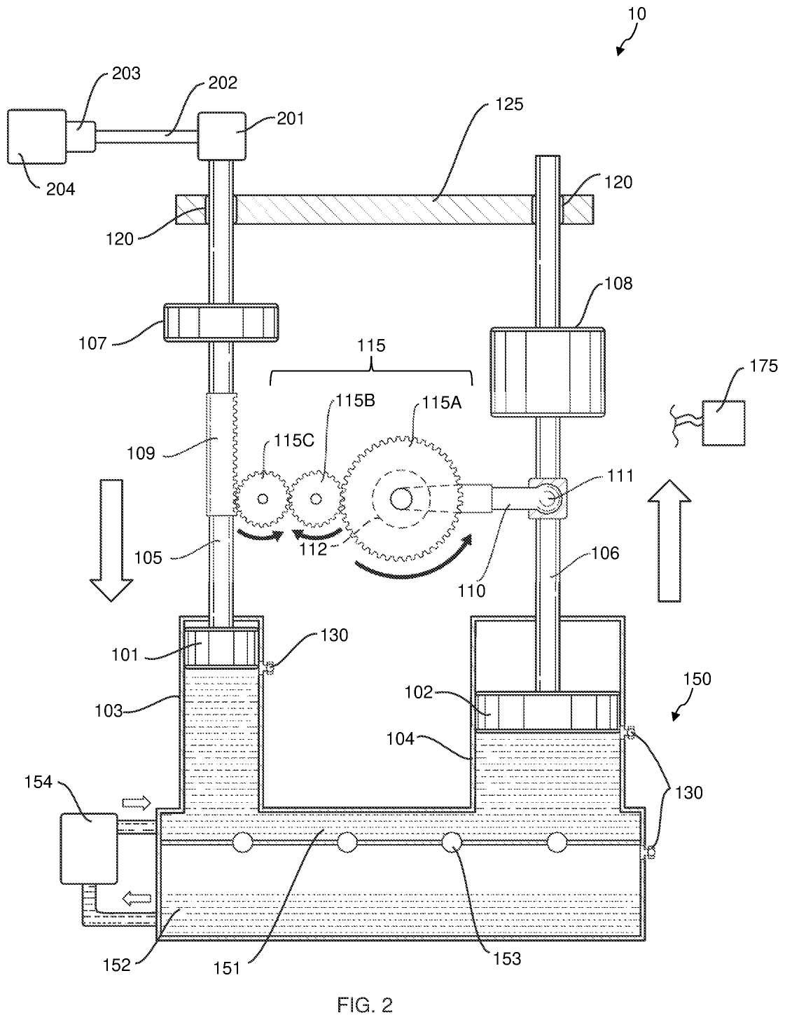

The top portion 151 of the fluid chamber 150 may be controlled, in part, by a fluid control 154, such as a fluid pump, to inject or eject fluid within the top portion 151 and the piston chambers 103, 104. When filled with a fluid, the piston chambers 103, 104 and the top portion 151 together contain a contiguous body of fluid. As illustrated by FIG. 2, when the piston chambers 103, 104, are filled with fluid and the first piston 101 is at the top of its upstroke while the second piston 102 is at the bottom of its downstroke, downward movement of the first piston 101 will cause a reciprocating upward motion from the second piston 102, as fluid within the piston chambers 103, 104 is displaced. The diameters of the first piston 101 and the corresponding first piston chamber 103 are materially smaller than the diameters of the second piston 102 and the corresponding second piston chamber 104. The difference in diameters between the first piston 101 and first piston chamber 103 and the second piston 102 and second piston chamber 104 results in the first piston having 101 hydraulic leverage over the second piston 102, based upon Pascal's Law.

The lever bar 110 is variable in length to account for the linear reciprocating motion of the piston rod 105, 106 in relation to the mechanical connection 115. A variable lever bar 110 allows for the lever bar to remain pivotally connected to the second piston rod 106 by means of a ball and socket joint 111 or other mechanical means while maintaining a connection to the mechanical connection 115. In a preferred example, the lever bar 110 is a telescopic bar made out of either a metal, alloy, or plastic material whose length telescopes on the upstroke of the second piston 102 and contracts on its downstroke of the second piston 102.

In a preferred example, the mechanical connection 115 connects to each of the piston rods 105, 106 by means of the rack gear 109 attached on or integrated into the first piston rod 105, articulating with one end of the mechanical connection 115. The end of the mechanical connection 115 opposite the rack gear 109 is connected to the lever bar 110 which is pivotally connected to the second piston rod 106. The mechanical connection 115 may further have the ratcheting mechanism 112, that, when disengaged provides no meaningful resistance from the lever bar 110 to the counterclockwise motion of the first gear 115a during the downstroke of the first piston 101 and the upstroke of the second piston 103. FIG. 3 illustrates the cross-sectional view of FIG. 1 where the engine 10 is at the end of the downstroke of the first piston 101 and the upstroke of the second piston 102.

The plurality of gears within the mechanical connection 115 are configured to correspond with the linear motions of the piston rods 105, 106. As previously described, depending upon the amount of hydraulic leverage which the first piston 101 has over the second piston, in some embodiments, the first gear 115a may have a radius that is 5 times larger than the radius of the plurality of remaining gears, if for instance the hydraulic leverage the first piston 101 has over the second piston is 5:1.

Focusing now on the components of the fluid chamber 150, in one possible embodiment of the fluid control, 154, the fluid chamber 150 may have a top portion 151 and a dump reservoir 152 positioned below the top portion. Positioned between the top portion 151 and the dump reservoir 152 is a plurality of dump reservoir valves 153. In some examples, the plurality of dump reservoir valves 153 may be solenoid operated. The dump reservoir valves 153 fluidly connect the top portion 151 to the dump reservoir 152. When the dump reservoir valves 153 are open, fluid exits the top portion 151 and enters the dump reservoir 152. A pump may fluidly connect the dump reservoir 152 to the top portion 151. In some examples, the fluid control 154 may be used to drain fluid from the top portion 151 into the dump reservoir 152. In other examples, the fluid control 154 may include a plurality of pumps moving fluid between the top portion 151 and the dump reservoir 152.

The dump reservoir 152 has an air vent 130 to release air. As fluid enters the dump reservoir 152 and displaces air, the air vent 130 allows air to exit the dump reservoir 152. In some examples, the air vent 130 in the dump reservoir 152 may be a continuously open valve positioned above a high fluid level mark in the dump reservoir. Each of the piston chambers 103, 104 also has an air vent 130 for displacement of air when each of the piston chambers 103, 104 are being filled with the fluid by the fluid control 154. These piston chamber air vents 130 are open when fluid is entering the top portion 151, and close once the air has been displaced and the fluid chamber 150 is substantially full and ready to be used for hydraulic leverage. The air vent 130 is positioned in the first piston chamber 103 where the first piston 101 is at the top of its upstroke between the empty first piston chamber 103 space below the first piston 101 and the bottom edge of the first piston 101 to allow for complete displacement of air when the first piston chamber 103 is being filled with fluid by the pump or other mechanism of the fluid control 154. The opening of the air vent 130 may be positioned in the second piston chamber 104 where the second piston 102 is at the bottom of its downstroke between the empty chamber space below the second piston chamber 104 and the bottom edge of the second piston 102 to allow for complete expulsion of air when the second piston chamber 104 is being filled with fluid by the fluid control 154.

A sensor 175 is electrically connected to both the fluid control 154 and to the dump reservoir valves 153. The sensor 175 sends electrical signals based upon either the position of one of or both pistons 101, 102 or the fluid level in the top portion 151. The electrical signal sent by the sensor 175 signals the dump reservoir valves 153 to open or close. When the sensor 175 signals the dump reservoir valves 153 to open, fluid may exit the top portion 151. The sensor 175 may also send an electrical signal to the fluid control 154 to activate it, thereby transferring fluid into the top portion 151.

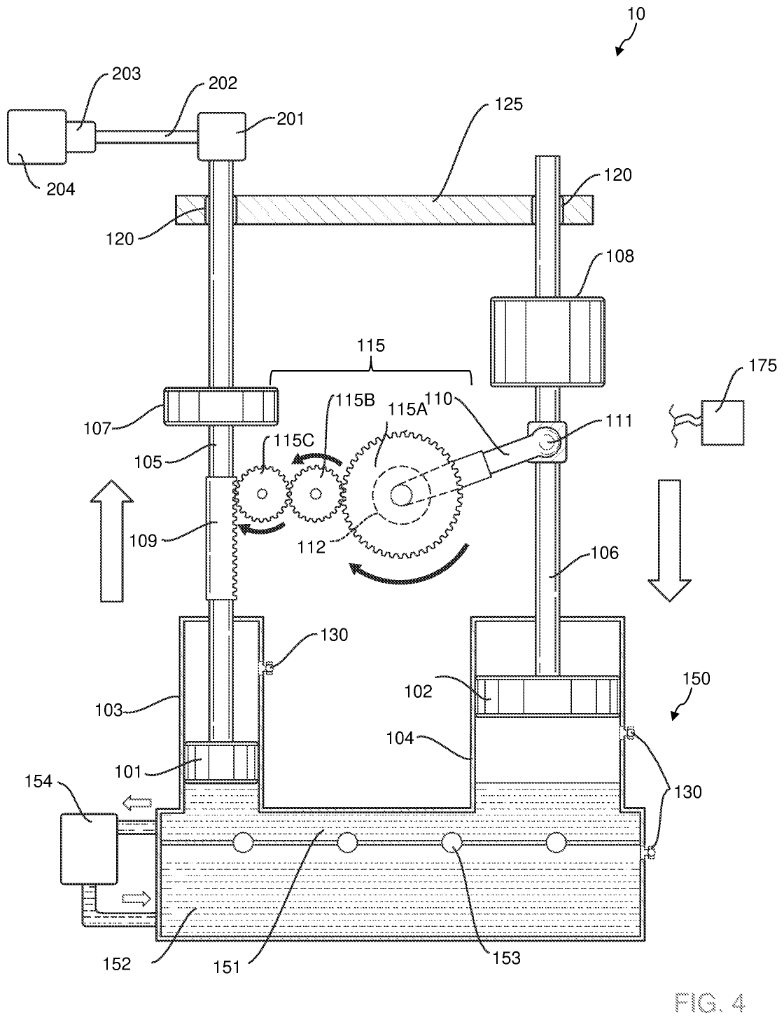

In the preferred example, the sensor 175 will send a signal to fluid control 154 to switch it into an off position following full fluid levels in each of the first piston chamber 103 and second piston chamber 104 beneath each of the first 101 and second pistons 102, respectively, prior to initiation of the downstroke of the first piston 101. As depicted in FIG. 2, the downstroke of the first piston 101 and the upstroke of the second piston 102 is initiated once there is a full fluid level beneath both of the pistons 101, 102 in each of the chambers 103, 104. On completion of the downstroke of the first piston 101 and the upstroke of the second piston 102, the sensor 175 sends a signal to the dump reservoir valves 153 to open and/or a signal to the fluid control 154 to transfer fluid out of the top portion 151. The sensor 175 sends a signal to the dump reservoir valves 154 to close and/or an off signal to the fluid control 154 once the fluid level in the second piston chamber 104 is just below the bottom of the second piston 102 when the second piston 102 is at the bottom of its downstroke. At this point, the upstroke of the first piston 101 and the downstroke of the second piston 102 is initiated as depicted in FIG. 4.

In another example the sensor 175 is electrically connected to a solenoid. The solenoid is positioned proximate to one of the piston rods 105, 106, whereby the solenoid restrains movement of at least one of the piston rods 105, 106 when active. In the preferred example, the sensor 175 is electrically connected to a solenoid to restrain the movement of the first piston rod 105 at the end of the upstroke of the first piston 101, thus holding the first piston 101 and first piston rod 105 at its maximum up travel position. During this time, the second piston 102 and second piston rod 106 are in their maximum down travel position. The sensor 175 sends a signal to the fluid control 154 to fill the top portion 151.

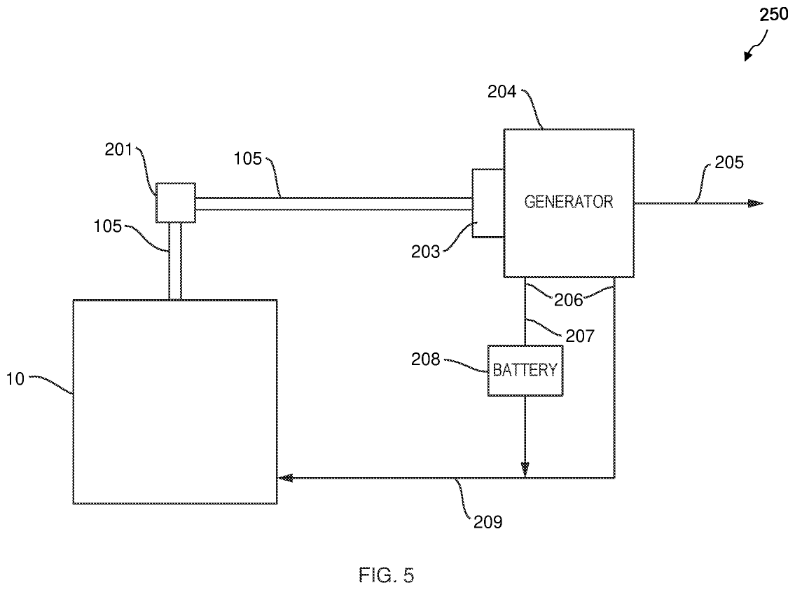

FIG. 5 illustrates a schematic of the engine-generator assembly 250. At least one of the piston rods 105, 106 is connected to a conversion assembly 201, wherein the conversion assembly 201 converts the linear motion of the at least one piston rod 105, 106 into rotational motion. The conversion assembly 201 is any linear-to-rotational motion converter. In some examples, the conversion assembly 201 may be a crank mechanism. In another example, the conversion assembly 201 is a gear assembly converting the linear motion of at least one of the piston rods 105, 106 into rotational motion. In yet another example, the conversion assembly 201 may be a scotch yoke.

The conversion assembly 201 is mechanically connected to a driveshaft 202. The driveshaft is further connected to a generator 204. The linear motion of the piston rod 105, 106 is converted into rotational motion by the conversion assembly 201. The driveshaft 202 connected to the conversion assembly 201 rotates at a speed corresponding to the linear motion of the piston rod 105, 106. In some examples, the driveshaft 202 mechanically connects directly with the generator 204, wherein the rotational motion of the driveshaft 202 drives the generator 204. In the preferred example, a gearbox 203 is connected to the generator 204 and is used to connect the driveshaft 202 to the generator 204. The gearbox 203 functions to convert the rotational speed of the driveshaft 202 to a higher revolution per minute (RPM). In some examples, the gearbox 203 may be a fixed-ratio gearbox 203 system. In other examples, the gearbox 203 may be a multi-ratio gearbox 203 system.

The generator 204 of the engine-generator assembly 250 may output two electrical power sources 205, 206, wherein one of the electrical power sources 205, 206 is configured to connect to an external power input. In some examples, the electrical power output of one of the electrical power sources 205, 206 is materially less than the other electrical power source 205, 206. The materially higher electrical power source 205, 206 is configured to connect to an external power input.

In the following example, the first power source 205 is materially higher than the other electrical power source 206. The first power source 205 may be configured to connect with a generator cord, which may be used to electrically power appliances, and other electrical fixtures. In another example, the first power source 205 is configured to connect with a generator transfer switch to allow a user to switch between grid electrical power and generator electrical power. In another example, the first power source 205 may be connected to a transformer. In a further example, the first power source 205 may be connected to a step-up transformer. In another example, the first power source 205 may be connected to a step-down transformer. In yet another example, the generator 204 may produce enough electrical power, such that the first power source 205 is connected to a step-up transformer for electrical power transmission. External inputs may mean any appliance, apparatus, building, or facility that requires an electrical power supply.

One of the electrical power sources 205, 206 may be configured to electrically connect with a battery charging circuit 207. The battery charging circuit 207 may be further electrically connected to an engine operational circuit 209, wherein the engine operational circuit 209 is configured to connect with the engine 10. In some examples, the second power source 206 may have a lower electrical power output than the first power source 205. In some examples, it is the second power output 206 that connects to the battery charging circuit 207. In yet another example, the battery charging circuit 207 may have a step-down transformer to account for the possibility of a lower required electrical power input from the second electrical power source 206. The battery charging circuit 207 may further have a battery 208.

The battery charging circuit 207 is further electrically connected to the engine operational circuit 209. The engine operational circuit may be configured to electrically connect with the sensors 175, the fluid control 154 (including any related pump), the dump reservoir valves 153, and the ratcheting mechanism, 112, which require electrical power to function. The engine operational circuit 209 serves to electrically power various components of the engine 10, such that efficiency of the functioning of the engine 10 and the engine-generator assembly 250 is greatly increased. In some examples, the power sources 205, 206 may directly electrically connect with the engine operational circuit 209. In this example, the need for a battery charging circuit 207 is obviated. In other examples, the power sources 205, 206 may directly electrically connect with the sensors 175, the fluid control 154, the dump reservoir valves 153, and the ratcheting mechanism, 112. In this example, the need for the battery charging circuit 207 and the engine operational circuit 209 is obviated.

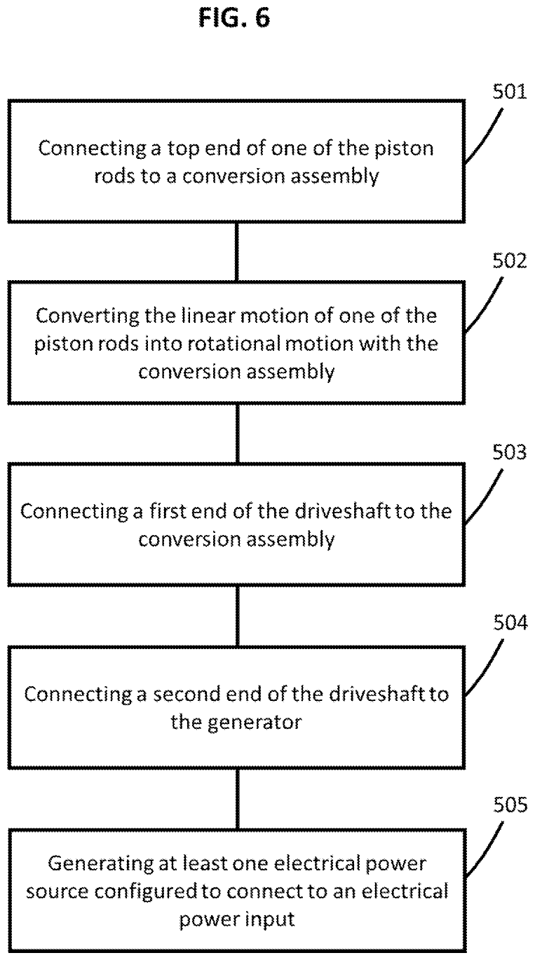

FIG. 6 illustrates a flowchart method to use the engine-generator assembly 250 of FIG. 5. In some examples, the method step 501 has the steps of connecting a top end of one of the piston rods 105, 106, to a conversion assembly 201. The method step 502 has the steps of converting the linear motion of one of the piston rods 105, 106 into rotational motion with the conversion assembly 201. The method step 503 has the steps of connecting a first end of the driveshaft 202 to the motion converter 201. The method step 504 has the steps of connecting a second end of the driveshaft 202 to the generator 204. The method step 505 has the steps of generating at least one electrical power source 205, 206 configured to connect to an electrical power input. One with ordinary skill in the art would recognize that the method to use the engine-generator assembly 250 is not restricted to being performed in these steps. For example, the driveshaft 202 may be connected to the generator 204 as a first step.

In some examples of a method to use the engine-generator assembly 250, connecting the second end of the driveshaft 202 to the gearbox 203 is preferred. The gearbox 203 may be connected to the generator 204 prior to connecting the driveshaft 202. Alternatively, the gearbox 203 may first be connected to the driveshaft 202, and then subsequently connected to the generator 204. Connecting the driveshaft 202 to the gearbox serves as a method to increase the RPM that is input into the generator 204. For example, if the driveshaft 203 is rotating at a speed of 14 RPM, a fixed-ratio gearbox 203 may increase the rotational speed to 1,500 RPM or higher, thus making the rotational speed input into the generator 204 higher than what would be input without connecting the gearbox 203 to the generator 204. In other examples, a multi-ratio gearbox 203 allows a user to change the rotational speed input into the generator 204 without affecting the rotational speed of the driveshaft 203.

In some examples, the electrical output of the engine 10 can be used, in part, to aid in powering the engine 10. Outputting two power sources 205, 206 is done, where one power source 205, 206 is configured to provide electrical power to external inputs, and the other power source 205, 206 is configured to provide electrical power to circuitry within the engine-generator assembly 250. Connecting one of the power sources 205, 206 to a battery charging circuit 207 can provide electrical power to aid in the function of the engine 10. Storing extra energy may be done by connecting the battery charging circuit 207 to a battery 208. Connecting the battery 208 and/or the battery charging circuit 207 to the engine operational circuit 209, and further connecting the engine operational circuit 209 to the fluid control 154, dump reservoir valves 153, sensor 175, and the ratcheting mechanism, 112, if electrically powered, completes the circuit. In some examples, connecting one of the power sources 205, 206 to the fluid control 154, dump reservoir valves 153, sensor 175, and the ratcheting mechanism, 112, if electrically powered, may provide enough additional electrical power to sustain the function of the engine-generator assembly 250 without the need for the battery charging circuit 207. In other examples, connecting the battery 208 to the engine operational circuit 209 may be sufficient to sustain the functioning of the engine-generator assembly 250. In this example, the power sources 205, 206 are not connected to the battery charging circuit 207 or battery 208. In this example, a separate battery charging circuit 207 connected to an external power supply for battery 208 recharging purposes. Alternatively, the battery 208 may be replaced when it is depleted.

In some example methods, connecting the driveshaft 202 to a gearbox 203 is preferred. The gearbox 203 converts the slower rotational speed of the driveshaft 202 input into the generator 204 to be increased. Generating two power outputs may be preferable wherein one of the electrical power sources 205, 206 provides electrical power. Connecting one of the electrical power sources 205, 206 to a transformer system for electrical power propagation to several different electrical power inputs may be preferred.

The following examples provide for an operational sequence of the engine 10. FIG. 1 illustrates a cross-sectional view of the engine with the first piston 101 at its maximum up-travel position and the second piston 102 at its maximum down-travel position. The sensor may be a piston 101, 102 position sensor 175 and/or a fluid volume sensor 175. The sensor 175 had previously sent an off signal to the fluid control 154, such that the piston chambers, 103, 104 below each of the pistons 101, 102 are not full of fluid. The first piston 101 is held at its maximum up-travel position by leverage advantage of the second piston 102 transferred to the first piston rod 105 through the mechanical connection 115 by the lever bar 110 which is now horizontal in relation to the ground.

FIG. 2 illustrates the cross-sectional view of FIG. 1 where the engine is initiating the downstroke of the first piston 101 and the upstroke of the second piston 102. The sensor 175 sends an on signal to the fluid control 154 to transfer fluid from the dump reservoir 152 to the top portion 151. Fluid is pumped into the top portion 151, which remains at atmospheric pressure. The air vents 130 are open during this time to allow the fluid to displace air present in the top portion 151. When the fluid control 154 is on, the fluid in the engine 10 is not under pressure, such that the fluid control 154 will not have to overcome any added resistance to replenish the fluid. Furthermore, only a partial amount of fluid in each of the piston chambers 103, 104 was previously evacuated, so relatively very little fluid will need to be transferred by the pump to refill each of the piston chambers 103, 104. The sensor 175 detects when the first 103 and second 104 piston chambers are full of fluid. Upon the sensor 175 detecting full fluid in the first 103 and second 104 piston chambers, a signal is sent to disengage the ratcheting mechanism, 112, holding the first piston 101 in its maximum up-travel position. Additionally, a signal is simultaneously sent by the sensor 175 to turn off the fluid control 154. The first piston 101 now begins its descent by its hydraulic leverage over the second piston 102.

FIG. 3 illustrates the cross-sectional view of FIG. 1 where the engine 10 is at the end of the downstroke, wherein the first piston 101 is at its maximum down travel position and the second piston 102 is at its maximum up travel position. Both the first 103 and second 104 piston chambers are filled with fluid. At this point the lever bar 110 is angled downwards with respect to a flat plane or the floor which the engine 10 is placed on and the ratcheting mechanism, 112, has remained disengaged such that no force is transmitted to the mechanical connection 115 by the lever bar 110.

FIG. 4 illustrates the initiation of the upstroke of the first piston 101 and the downstroke of the second piston 102. Once the second piston 102 has reached its maximum up-travel, the sensor 175, which may be a piston position sensor 175 or fluid level sensor 175, sends an electrical signal to the dump reservoir valves, 153, to momentarily open until sufficient fluid from the top portion 151 is ejected into the dump reservoir 152 such that the fluid level in the second piston chamber 104 is lowered just below the bottom of maximum down travel of the second piston 102 in the downstroke of the second piston 102. Fluid in the system at this point is under pressure, therefore opening the dump reservoir valves 153 will cause a rapid evacuation of fluid from the top portion 151. Once adequate fluid from the top portion 151 is evacuated, the sensor 175, which may be a fluid volume sensor 175 signals the dump reservoir valves 153 to close. To expedite the evacuation of fluid from the top portion 151 the fluid control 154 may be signaled by the sensor 175 to suction and transfer fluid to the dump reservoir from the top portion fluid chamber at the end of the downstroke of the first piston 101. In some examples, the fluid control 154 may be used in addition to the dump reservoir valves 153. In other examples, the fluid control 154 may be used in place of the dump reservoir valves 153. Following evacuation of the fluid, the sensor 175 signals the ratcheting mechanism 112 to engage. The fluid has been rapidly evacuated to the dump reservoir 153. As the second piston 102 falls, the first piston 101 reciprocally ascends to the top of its corresponding first cylinder chamber 103 via the clockwise rotation of the gear train 115 bringing the lever bar 110 horizontal. Once the upstroke is completed, the sensor 175, which may be a piston position sensor 175 or fluid level sensor 175 signals the fluid control 154 to refill the top portion 151 with fluid and another cycle is initiated.

1. An engine comprising:
a fluid chamber including a first piston chamber and a second piston chamber;
a first piston positioned within the first piston chamber;
a first piston rod connected to the first piston and extending outside the fluid chamber;
a second piston positioned within the second piston chamber;
a second piston rod connected to the second piston and extending outside the fluid chamber;
a mechanical connection extending between the first piston rod and the second piston rod,
wherein the second piston rod has a leverage advantage over the first piston rod when the mechanical connection is enabled; and
a fluid control connected to the fluid chamber wherein the first piston has a hydraulic leverage advantage over the second piston when the fluid chamber is filled with fluid.

2. The engine of claim 1, wherein the second piston rod is materially heavier than the first piston rod.

3. The engine of claim 1, further comprising a stabilization platform, wherein the stabilization platform has two apertures for receiving the first and second piston rods, each aperture having a friction reducer.

4. The engine of claim 1, further comprising:
a first weight platform at an upper portion of the first piston rod; and
a second weight platform at an upper portion of the second piston rod.

5. The engine of claim 1, wherein the mechanical connection comprises a plurality of gears with a gear ratio calibrated, starting from the first piston rod, equivalent to the hydraulic leverage which the first piston has relative to the second piston when the fluid chamber is full of fluid.

6. The engine of claim 1, wherein the mechanical connection comprises a plurality of gears comprising a first gear adjacent to the second piston rod which has a radius materially greater than a remainder of the plurality of gears.

7. The engine of claim 6, wherein the mechanical connection further comprises a ratcheting mechanism that provides no meaningful resistance in one direction of rotation.

8. The engine of claim 1, wherein the mechanical connection further comprises a lever bar, wherein a first end of the lever bar is connected to the second piston rod and a second end of the lever bar connected to the ratcheting mechanism.

9. The engine of claim 8, wherein the lever bar is variable in length.

10. The engine of claim 1, wherein a portion of the first piston rod has a rack gear.

11. The engine of claim 1, further comprising a sensor, wherein the sensor detects at least one of a position of the first piston, a position of the second piston, or a fluid level in the fluid chamber.

12. The engine of claim 1, further comprising a solenoid positioned proximate to one of the first and second piston rods, whereby the solenoid restrains movement of at least one of the first and second piston rods when active.

13. The engine of claim 1, wherein the fluid control further comprises a pump positioned to fill the fluid chamber with fluid.

14. The engine of claim 1, wherein at least one of the first and second piston rods is connected to a conversion assembly, wherein the conversion assembly converts linear motion into rotational motion.

15. A generator assembly comprising:
the engine of claim 14;
a driveshaft connected to the conversion assembly; and
a generator connected to the driveshaft.

16. The generator assembly of claim 15 further comprising:
a gearbox connected to the generator, wherein the gearbox connects the driveshaft to the generator.

17. The generator assembly of claim 15, wherein the generator outputs a first electrical power source and a second electrical power source, wherein one of the first and second electrical power sources is configured to connect to an external power input.

18. The generator assembly of claim 17 further comprising:
a battery charging circuit configured to connect to one of the first and second power sources;
an engine operational circuit configured to connect to the battery charging circuit and to the engine.

19. An engine comprising:
a fluid chamber including a first piston chamber and a second piston chamber, wherein the first piston chamber has a materially smaller diameter than the second piston chamber;
a single contiguous body of fluid contained within the fluid chamber including the first piston chamber and the second piston chamber;
a second piston positioned within the second piston chamber;
a first piston with a materially smaller diameter than the second piston positioned within the first piston chamber;
a first piston rod connected to the first piston and extending outside the first piston chamber;
a second piston rod connected to the second piston and extending outside the second piston chamber;
a mechanical connection extending between the first piston rod and the second piston rod, wherein the second piston rod has a leverage advantage over the first piston rod when the mechanical connection is enabled, wherein the mechanical connection drives the first piston to the top of the first piston chamber by the force of a weight of the second piston rod transmitted through the mechanical connection to the first piston rod;
a first weight platform attached to the first piston rod above the first piston chamber and above the mechanical connection between the first piston rod and the second piston rod;
a second weight platform attached to the second piston rod above the second piston chamber and above the mechanical connection between the first piston rod and the second piston rod; and
a fluid control connected to the fluid chamber wherein the first piston has hydraulic leverage over the second piston when the fluid chamber is filled with fluid,
wherein the fluid chamber allows the second piston to be driven to the top of the second piston chamber by the force of the falling weight of the first piston transmitted to the second piston by the hydraulic leverage which the first piston has over the second piston.

20. The engine of claim 19, wherein the mechanical connection comprises a plurality of gears with a gear ratio calibrated, starting from the first piston rod, equivalent to the hydraulic leverage which the first piston has relative to the second piston when the fluid chamber is full of fluid.

21. The engine of claim 19, wherein the mechanical connection comprises a plurality of gears comprising a first gear adjacent to the second piston rod which has a radius materially greater than a remainder of the plurality of gears.
